(19) United States
(12) Patent Application Publication
(10) Pub. No.: US 2022/0302716 A1
(43) Pub. Date: Sep. 22, 2022

(54) UNIVERSAL BATTERY PACK WITH LOAD BALANCING FOR ELECTRIC VEHICLES

(71) Applicant: Acton, Inc., Livermore, CA (US)

(72) Inventors: Peter Treadway, Pleasanton, CA (US); Andrew Tam, Livermore, CA (US)

(21) Appl. No.: 17/696,913

(22) Filed: Mar. 17, 2022

Related U.S. Application Data
(60) Provisional application No. 63/163,031, filed on Mar. 18, 2021.

(51) Int. Cl. H02J 7/00; B62K 3/00

(52) U.S. Cl. CPC H02J 7/0014; H02J 7/0045; H02J 7/0025; H02J 7/0063; B62K 3/002; H02J 7/0048; B62K 2202/00

(57) ABSTRACT

A universal battery is provided with load balancing and a battery module and an energy storage system electrically coupled to the battery module and configured to bidirectionally transfer energy from and to the battery module. The energy storage system is operable in a first operating state in which the energy is transferred from the energy storage system to the battery module to charge the battery module, and a second operating state in which the energy is transferred from the battery module to the energy storage system to discharge the battery module. An electrical connection electrically couples the energy storage system to a power source. A controller is operably coupled to the battery module and the energy storage system. The controller is configured to control a charging state of the battery module.

### CROSS REFERENCE TO RELATED APPLICATION

The present application claims priority from U.S. Provisional Patent Application No. 63/163,031 filed on Mar. 18, 2021, the disclosure thereof incorporated by reference herein in its entirety.

### BACKGROUND

### Field of the Invention

This invention relates generally to electric vehicles, and more particularly to universal battery packs for electric vehicles.

### Description of the Related Art

Battery balancing and battery redistribution refer to techniques that improve the available capacity of a battery pack with multiple cells (usually in series) and increase each cell's longevity. A battery balancer or battery regulator is an electrical device in a battery pack that performs battery balancing.

Balancing a multi-cell pack helps to maximize capacity and service life of the pack by working to maintain equivalent state-of-charge of every cell, to the degree possible given their different capacities, over the widest possible range.

Balancing can be active or passive. The term battery regulator typically refers only to devices that perform passive balancing. A full BMS might include active balancing as well as temperature monitoring, charging, and other features to maximize the life of a battery pack.

Battery balancing can be performed by; cell-to-battery; battery-to-cell; and be bidirectional

There is a need for improved universal battery packs with load balancing.

### SUMMARY

A universal battery includes load balancing with a battery module and an energy storage system electrically coupled to the battery module and configured to bidirectionally transfer energy from and to the battery module. The energy storage system is operable in a first operating state in which the energy is transferred from the energy storage system to the battery module to charge the battery module, and a second operating state in which the energy is transferred from the battery module to the energy storage system to discharge the battery module. An electrical connection electrically couples the energy storage system to a power source. A controller is operably coupled to the battery module and the energy storage system. The controller is configured to control a charging state of the battery module.

### BRIEF DESCRIPTION OF THE DRAWINGS

FIG. 1 illustrates an electric scooter according to embodiments of the disclosed technology.

FIG. 2 illustrates further detail of the electric scooter of FIG. 1.

FIG. 3 illustrates further detail of the deck assembly and latch of FIGS. 1 and 2.

FIG. 4 illustrates detail of the scooter of FIGS. 1 and 2 with the latch in an open position.

FIG. 5 illustrates further detail of the scooter of FIGS. 1 and 2 with the latch in an open position.

FIG. 6 illustrates detail of the scooter of FIGS. 1 and 2 with the latch in an open position.

FIG. 7 illustrates further detail of the scooter of FIGS. 1 and 2 during installation, or removal, of the deck assembly.

FIG. 8 illustrates a quick twist electrical soft connector according to embodiments of the disclosed technology.

FIG. 9 illustrates a cushioned electrical connector according to embodiments of the disclosed technology.

FIG. 10 illustrates a compound locking assembly according to embodiments of the disclosed technology.

FIG. 11A illustrates a portion of the scooter during removal or installation of the deck assembly.

FIG. 11B illustrates the retention device for the loose portions of the electrical cables of the scooter.

FIG. 12 illustrates a hidden latch mechanism for the scooter.

FIG. 13 illustrates a process for a user to install a removable deck assembly into an electric scooter according to embodiments of the disclosed technology.

FIG. 14 illustrates a process for a user to remove a removable deck assembly from an electric scooter according to embodiments of the disclosed technology.

FIG. 15 illustrates one embodiment of electric vehicle with public and private keys, and vehicle to vehicle communication.

FIGS. 16-25 illustrates various embodiments of the present invention with UVC light sources.

FIGS. 26 and 27 illustrate embodiments of the present invention with universal battery packs.

### DETAILED DESCRIPTION

Embodiments of the described technology provide electric scooters having top-swappable batteries. The batteries may be attached to the underside of the deck of the scooter to form a removable deck assembly. The deck assembly may be removed from the top of the scooter by operating a latch and lifting a handle of the assembly. The deck assembly may be returned to the scooter in a similar manner.

In some embodiments, the battery may be electrically coupled to a motor of the scooter by electrical cables and an electrical connector. The electrical connector may be a quick twist connector that is opened and closed by twisting its halves in opposite directions.

In some embodiments, instead of using electrical cables, the scooter and deck assembly may include electrical connectors that mate when the deck assembly is installed in the scooter. The electrical connectors may be surrounded by cushions that protect the connectors from micro vibrations, dirt and water, and the like.

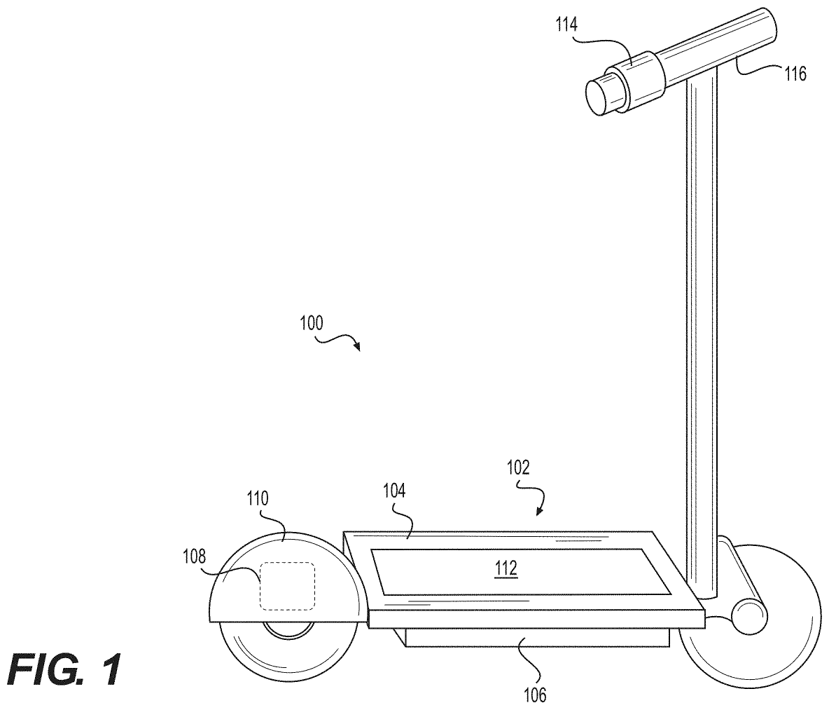

FIG. 1 illustrates an electric scooter 100 according to embodiments of the disclosed technology. It will be appreciated that an electric vehicle is an Actively means of carrying or transporting something such as an EV motor vehicle, including but not limited to a scooter, skateboard, skates, and the like.

Referring to FIG. 1, the scooter 100 includes a deck assembly 102 removably attached to a frame 104 of the scooter 100. The deck assembly 102 includes a battery case 106 mounted underneath a deck 112. The battery case 106 includes one or more batteries (not shown). The batteries are electrically coupled to an electric drive motor 108, which is protected by a housing 110. The scooter 100 may be steered by turning a handlebar 116. The speed of the motor 108 may be controlled using a throttle 114 mounted on the handlebar 116.

The electric scooter 100 is depicted in FIG. 1 as having only two wheels. However, it will be appreciated that the disclosed technology applies to scooters having any number of wheels. Furthermore, it will be appreciated that the disclosed technology applies to vehicles other than scooters, and having any number of wheels.

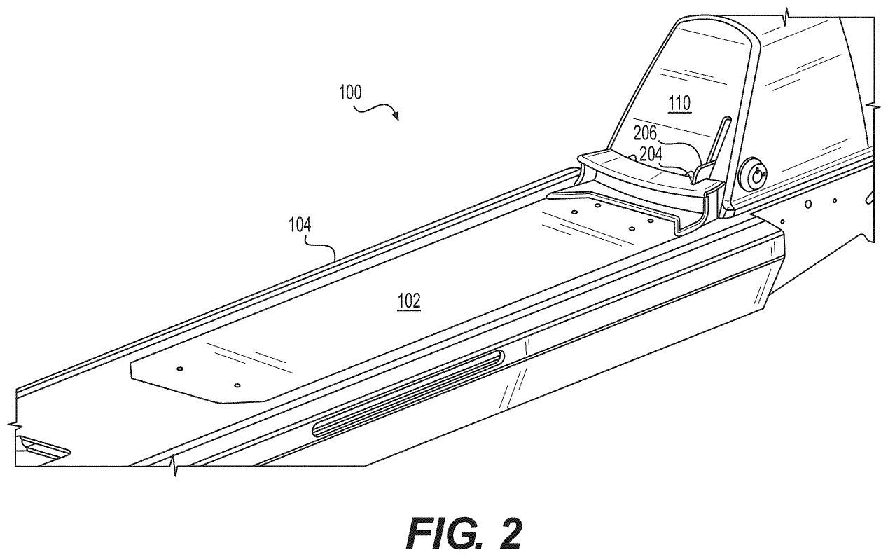

FIG. 2 illustrates further detail of the electric scooter 100 of FIG. 1. Referring to FIG. 2, the removable deck assembly 102 is held flush with the frame 104 by a latch 206 when engaged in a notch 204. The latch 206 may be controlled by a latch mechanism (not shown) disposed within the housing 110.

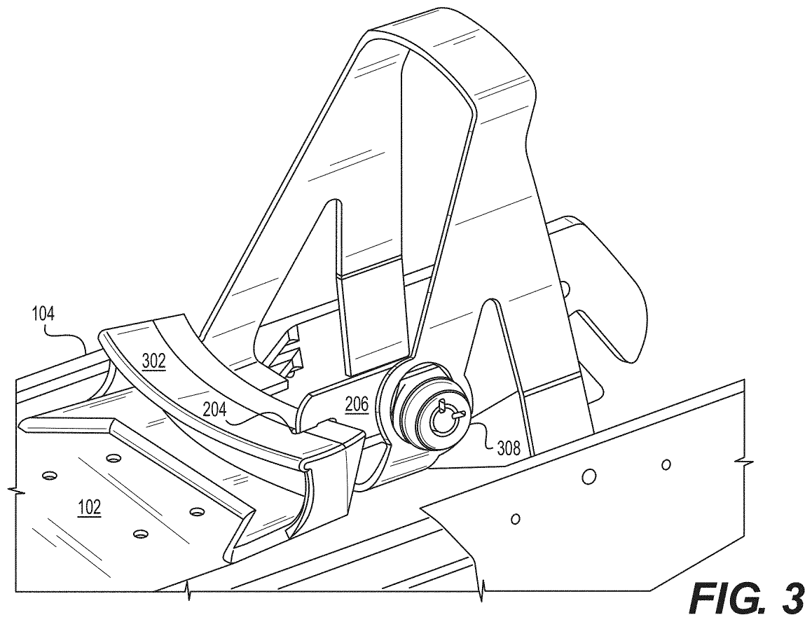

FIG. 3 illustrates further detail of the deck assembly 102 and latch 206 of FIGS. 1 and 2. Referring to FIG. 3, the deck assembly 102 may include a handle 302 to assist with the removal and installation of the deck assembly 102. The handle 302 may include a notch 204 to receive the latch 206. The deck assembly 102 may include a lock 308. The lock 308 may be operable to fix the latch 206 in an open position and/or a closed position, where the latch 206 secures the deck assembly 102 within the frame 104 when in the closed position. A key (not shown) may be inserted within lock assembly 308 to rotate the latch into, and out of, the notch 204, that is, between the closed position and an open position. When engaged with the notch 204, the latch retains the deck assembly 102 within the frame 104 of the scooter 100.

In the depicted embodiment, the lock assembly 308 is implemented as a physical lock, to be used with a physical key. But in other embodiments, the lock assembly 308 may be implemented in other ways. For example, the lock assembly 308 may be an electronic lock, which may be operated using an electronic key, fob, remote control, or the like. In embodiments where security is not required, the lock in the lock assembly 308 may be replaced with a knob, a button, or another mechanism. In any case, the lock assembly 308 may be hidden or disguised. This feature is especially useful in a ridesharing fleet, where users should not operate the lock assembly 308, or remove the deck assembly 102.

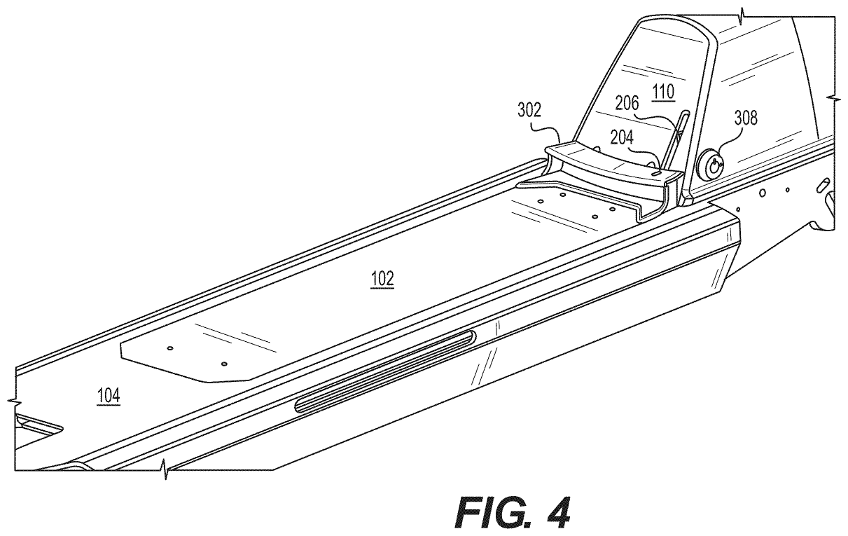

FIG. 4 illustrates detail of the scooter 100 of FIGS. 1 and 2 with the latch 206 in an open position. Referring to FIG. 4, the lock assembly 308 has been operated to rotate the latch 206 out of the notch 204. To protect the user from the latch, the latch 206 has been rotated to a position within the housing 110. The deck assembly 102 may now be removed from the scooter 100.

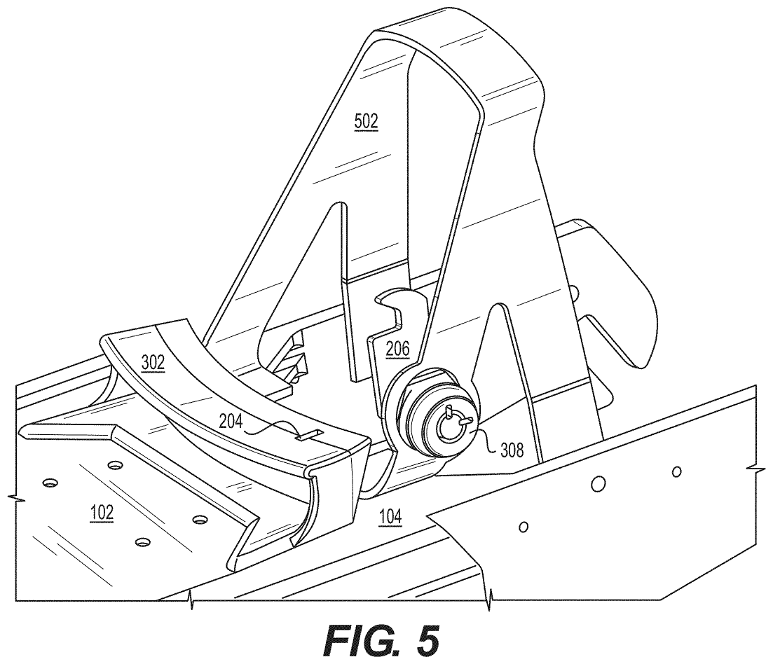

FIG. 5 illustrates further detail of the scooter 100 of FIGS. 1 and 2 with the latch 206 in an open position, and with the housing 110 removed. Referring to FIG. 5, the latch 206, and the lock assembly 308, are held in place by a strut 502 that is connected to the frame 104.

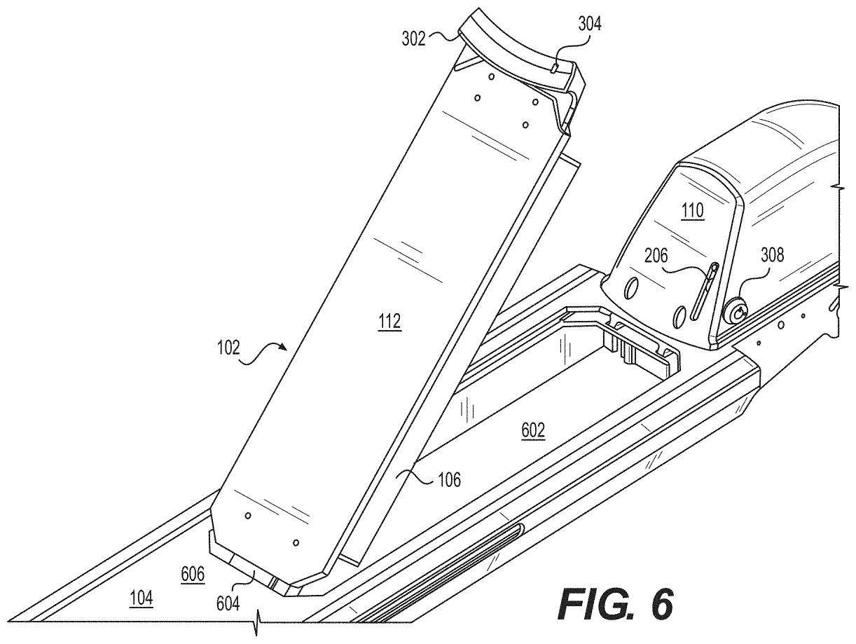

FIG. 6 illustrates detail of the scooter 100 of FIGS. 1 and 2 during installation, or removal, of the deck assembly 102. Referring to FIG. 6, the frame 104 has an upper surface 606, and an opening 602 in the frame 104 is visible. The opening 602 is formed so as to receive the deck assembly 102 when the deck assembly 102 is lowered into the opening of the frame from above the upper surface 606 of the frame. As can be seen in FIG. 6, the deck assembly 102 includes a protruding tongue 604 at the front of the deck assembly 102. During removal of the deck assembly 102, a user may lift the deck assembly 102 out of the opening of the frame 104 from above the upper surface 606 of the frame 104 by pivoting the deck assembly 102 upward about the tongue 604 using the handle 302, and then slide the deck assembly 102 slightly to the rear of the scooter 100 to disengage the tongue 604 from the frame 104. During installation of the deck assembly 102, a user may first insert the tongue 604 into the frame 104, pivot the deck assembly 102 downward into the opening 602 until flush with the frame 104, and then rotate the latch 206 into the notch 204 to secure the deck assembly 102 within the frame 104.

Also visible in FIG. 6 is the battery case 106. The battery case 106 may include one or more batteries (not shown), which may be cushioned with foam pads or similar materials. The battery case 106 may be integrated with the deck 112 to form the deck assembly 102, as noted above. The deck assembly 102 may be watertight to prevent damage to the batteries, and may be of automotive quality. This arrangement provides several advantages. In current designs, the battery case is mounted underneath a non-removable deck, for example using screws. In such designs, the batteries can only be removed by inverting the scooter, and unscrewing the battery case. During this process, the scooter may be damaged, the battery case may be damaged, and the screws may be lost. Furthermore, the user must have a tool such as a screwdriver. In contrast, in the described embodiments, the batteries may be removed without tools, by simply operating the latch 206 and lifting out the deck assembly 102. No tools are required. The scooter need not be inverted, and may remain on the ground, in a rack, or the like.

Other advantages are especially applicable to a fleet of shareable electric scooters. In current fleets, the scooters are generally collected each evening, and taken to a charging facility where the batteries are charged. The charged scooters are then returned to scooter sharing locations the next morning. But in this arrangement, the scooters are unavailable for sharing while being charged. And this arrangement requires two trips per day: one trip to collect the scooters, and another trip to deploy them.

Embodiments of the disclosed technology solve both of these problems. With the disclosed removable deck assembly, the scooters need not be collected. Instead, only the deck assemblies may be collected. The scooters may be left in the sharing location, sharing racks, and the like. Furthermore, with a fleet of similar scooters, the deck assemblies are interchangeable. Therefore, an operator can replace a discharged battery pack with a fresh battery pack, requiring only one trip, and keeping the scooter available while the discharged battery pack is recharged. And because the disclosed deck assemblies are much smaller than the scooters, many more scooters can be serviced by a single truck than with current arrangements. In addition, because the disclosed deck assemblies weigh less than the scooter, there is less likelihood an operator will be injured while lifting them.

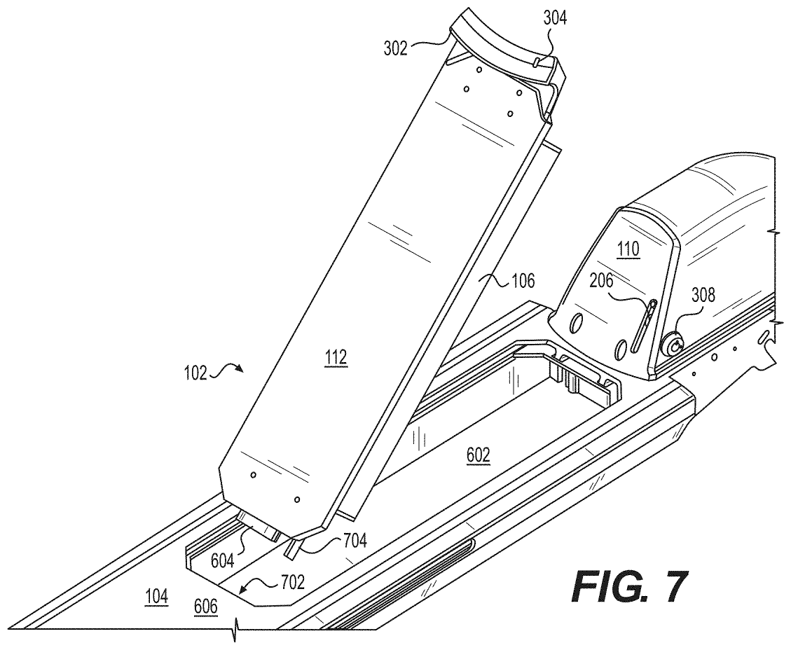

FIG. 7 illustrates further details of the scooter 100 of FIGS. 1 and 2 during installation, or removal, of the deck assembly 102 Referring to FIG. 7, the tongue 604 of the deck assembly 102 is free of the frame 104. As can be seen in FIG. 7, the frame 104 may feature a double-wall construction for rigidity and light weight. In the disclosed embodiment, a slot 702 may be formed between the walls of the frame 104 to receive the tongue 604. Also visible in the embodiment of FIG. 7 is a portion of an electrical power cable 704. The power cable 704 may provide power to the motor 108 of the scooter 100. To separate the deck assembly 102 from the scooter 100, the user may operate a connector of the power cable 704, as described in detail below.

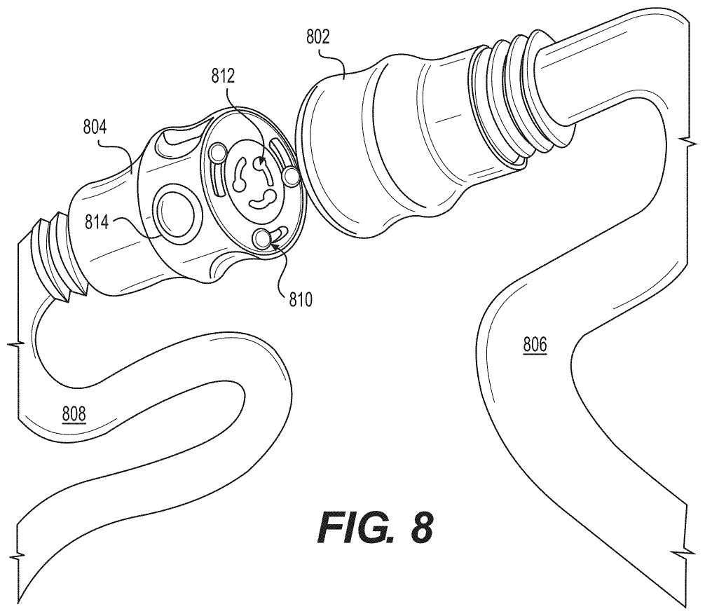

FIG. 8 illustrates a quick twist electrical soft connector according to embodiments of the disclosed technology. As used herein, the term “soft connector” is used to refer to a connector having two halves, where at least one of the halves is coupled to a flexible electrical cable. In some embodiments, the term “soft connector” is used to refer to a connector where both halves of the connector are coupled to respective flexible electrical cables. As described below, the flexible cable(s) serve to insulate the scooter from micro vibrations, a problem unique to vehicles such as scooters that have small, hard wheels. Referring to FIG. 8, the soft electrical connector includes a male half 802 and a female half 804. The halves 802, 804 are formed at the ends of electrical cables 806, 808, respectively. The illustrated soft connector is a quick twist connector that is opened and closed by twisting its halves 802, 804 in opposite directions. Accordingly, the female half 804 of the soft connector includes a plurality of curved slots 810, each including a round opening to receive a respective locking pin (not shown) of the male half 802. The electrical connectors may be implemented in a similar manner, as shown at 812.

In some embodiments, one half of the soft connector may include a locking indicator 814. The locking indicator 814 may shine red until the soft connector is completely closed, whereupon the indicator 814 may switch to green to indicate a positive lock of the soft connector.

One advantage of the disclosed quick twist electrical soft connector is that it mitigates the problem of micro vibrations. Vehicles such as automobiles and s are subject to vibrations caused by imperfections in the road surface. Vehicles with small, hard wheels, such scooters, are subject to these vibrations, and also to micro vibrations, which are caused by tiny imperfections in the road surface, for example such as the pebbles in a conglomerate road surface. Electrical connectors in particular are adversely affected by micro vibrations, which cause the mating electrical parts to rub together and thereby deteriorate. Gold plating on electrical connectors is particularly subject to this deterioration. In the disclosed embodiments, the lengths of electrical cables 806, 808 isolate the electrical connector from these micro vibrations, greatly reducing any wear the electrical connectors 812 experience.

Another advantage of the disclosed quick twist electrical soft connector is that it encourages users not to pull on the cables 806, 808 to open the soft connector. In conventional electrical connectors with no twist lock mechanism, users may be tempted to pull on the cables to open the connector. This abuse may shorten the life of the electrical cable and electrical connector considerably. But this is not possible with the twist connector. The user must grasp the soft connector halves in order to twist them in opposite directions. Consequently, the electrical soft connector and electrical cables 806, 808 may enjoy a longer lifespan.

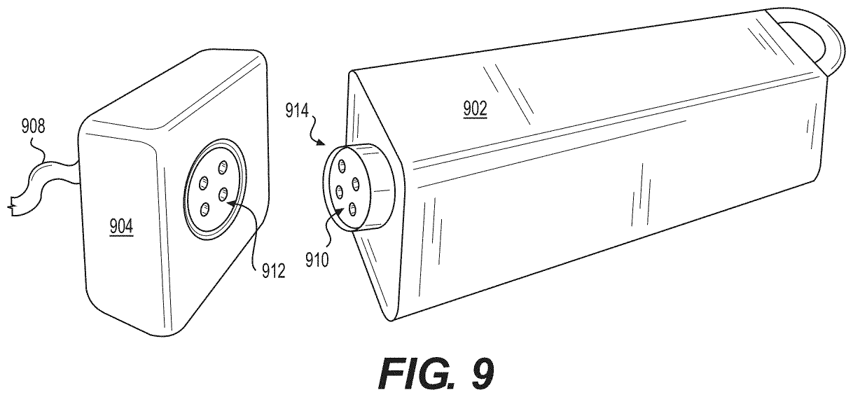

FIG. 9 illustrates a cushioned electrical connector according to embodiments of the disclosed technology. Referring to FIG. 9, a deck assembly 902 that includes a battery pack may be pressed against an elastic mounting block 904 during installation. The deck assembly 902, and the mounting block 904, include respective electrical connectors 910, 912 that are mated during installation of the deck assembly 902, thereby providing power from the battery pack to the motor through an electrical power cable 908. The mounting block 904 may be fabricated of an elastic material such as rubber to cushion the electrical connectors 910, 912 from micro vibrations. In the embodiment of FIG. 9, the elastic mounting block 904 is disposed upon the scooter.

But in other embodiments, an elastic mounting block may be disposed on the deck assembly 902 instead, or as well. For example, as shown in FIG. 9, the deck assembly 902 may include a second elastic mounting block 914 to further isolate the electrical connectors 910, 912 from micro vibrations. These elastic mounting blocks 904, 914 may also form a seal about the electrical connectors 910, 912 that protects the electrical connectors 910, 912 from water, dirt, and the like.

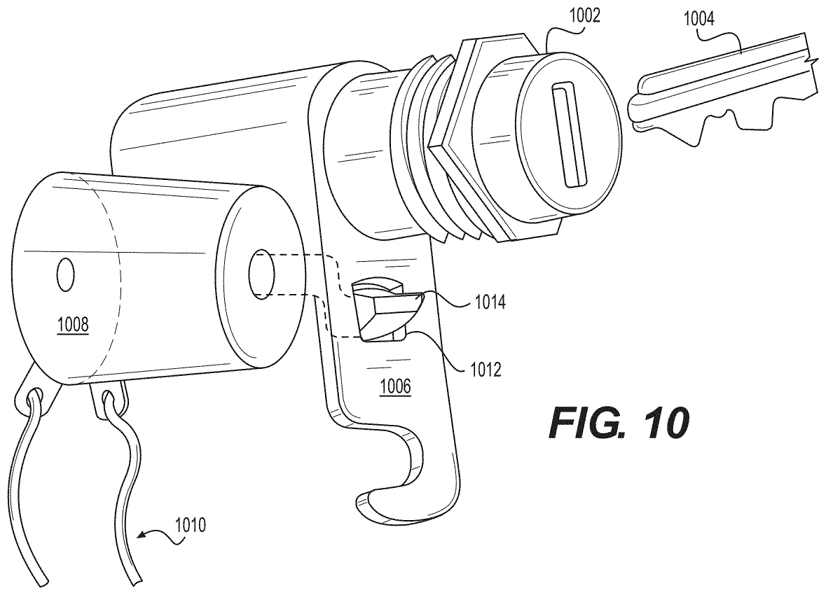

FIG. 10 illustrates a compound locking assembly according to embodiments of the disclosed technology. Referring to FIG. 10, the compound locking assembly includes a mechanical lock 1002, which may be operated by a physical key 1004 to rotate a latch 1006 into a corresponding notch, such as notch 204 in handle 302 of deck assembly 102, as shown in FIG. 3.

Referring again to FIG. 10, the compound locking assembly may also include an electric lock 1008, which may receive power through electrical cables 1010, and which may be operated using an electronic key, fob, remote control, or the like. When operated, the electric lock 1008 may insert a tab 1014 into an opening 1012 formed in the latch 1006 of the mechanical lock 1002, thereby preventing operation of the mechanical lock 1002.

In some embodiments, the electric lock 1008 may operate in parallel with the mechanical lock 1002. In such embodiments, the electric lock 1008 may insert the tab 1014 into a notch in the deck assembly. In such embodiments, both locks 1002, 1008 must be opened to release the deck assembly.

In some embodiments, the tab 1014 of the electrical lock 1008 may have multiple stops. In one of the stops, the tab 1014 engages the latch 1006 of the mechanical lock 1002, thereby preventing its operation, as illustrated in FIG. 10. In another of the stops, the tab 1014 engages a notch in the deck, thereby preventing its removal, as described above. In still another one of the stops, the tab 1014 engages neither the latch 1006 nor the deck assembly, thereby permitting operation of the mechanical lock 1002, and removal of the deck assembly.

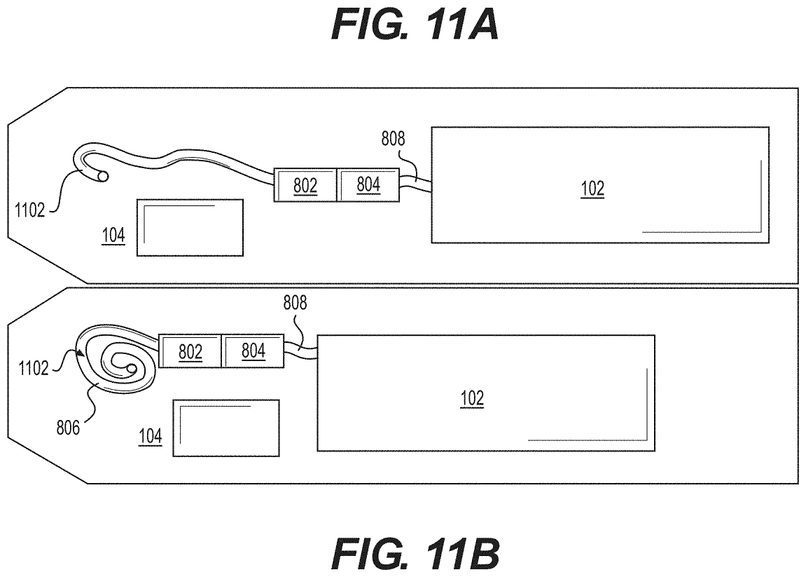

In embodiments that include an electrical power cable, the scooter may include a mechanism to retain and protect the cable when the deck assembly is installed. FIGS. 11A, B illustrate one such mechanism according to embodiments of the disclosed technology. In FIGS. 11A, B the mechanism is illustrated for the electrical cables 806, 808 and electrical connector 802, 804 of FIG. 8. However, the mechanism may be employed with any electrical cable and electrical connectors.

FIGS. 11A-B are top views of the scooter, with the rear of the scooter at the left. FIG. 11A illustrates a portion of the scooter 100 during removal or installation of the deck assembly 102. The battery pack in the deck assembly 102 is electrically coupled to the motor 108 by the electrical cables 806, 808 and the electrical connectors 802, 804. As shown in FIG. 11A, during installation or removal of the deck assembly 102, one or both of the electrical cables 806, 808 are extended to facilitate installation and removal, and to provide easy access to the electrical connectors 802, 804. A retention device 1102 permits this extension of the electrical cables 806, 808.

When the deck assembly 102 is installed in the frame 104 of the scooter 100, the retention device 1102 retracts, guides, organizes, and stores the loose portions of the electrical cables 806, 808, as shown in FIG. 11B. For example, the electrical cables 806, 808 may be retracted into a channel (not shown) formed in the frame 104 of the scooter 100. The retention device 1102 may be implemented as a spring-loaded device, for example such as a winding mechanism or the like. The winding mechanism may be similar to that used in spring-loaded tape measures, with the electrical cables 806, 808 taking the place of the tape. One benefit of this mechanism is that a technician working on the scooter does not have to manually feedback the slack in the electrical cables 806, 808, that results from the removal of the battery pack. When retracted, the electrical cables 806, 808, and the electrical connectors 802, 804, are protected from pinching, wear, and the like.

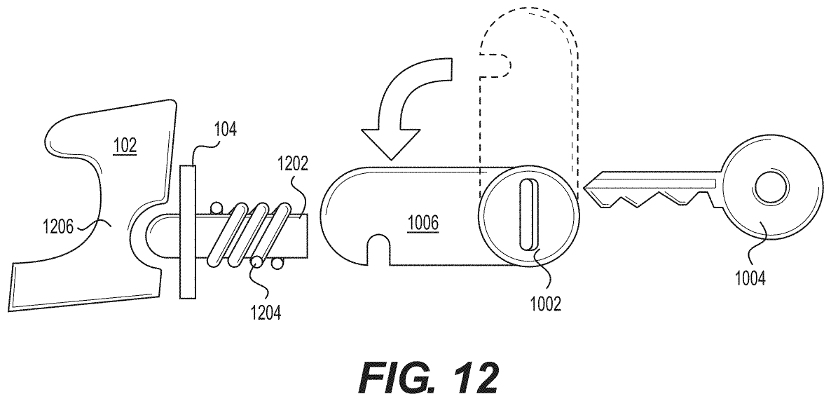

In some embodiments, the latch that retains the deck assembly 102 within the frame 104 of the scooter 100 may be hidden within a structure such as the frame 104 or the housing 110 of the scooter 100 so that it cannot be seen, and to protect the latch from damage. One such embodiment is illustrated in FIG. 12. The embodiment of FIG. 12 is illustrated for the mechanical lock 1002, physical key 1004, and latch 1006 of FIG. 10. However, the described embodiment may be employed with any lock, key, and latch, or with a keyless latch where the lock and key are replaced by a knob or the like.

Referring to FIG. 12, the described embodiment also includes a pin 1202 and a spring 1204 that biases the pin 1202 against the frame 104. When the lock 1002 and key 1004 are used to rotate the latch 1006 downward into a locked position, the latch 1006 forces the pin 1202 through a hole in the frame 104 into a notch 1206 formed in the deck assembly 102, thereby retaining the deck assembly 102 within the frame 104. When the lock 1002 and key 1004 are used to rotate the latch 1006 upward into an unlocked position, the spring 1204 backs the pin 1202 out of the notch 1206 so the deck assembly may be removed.

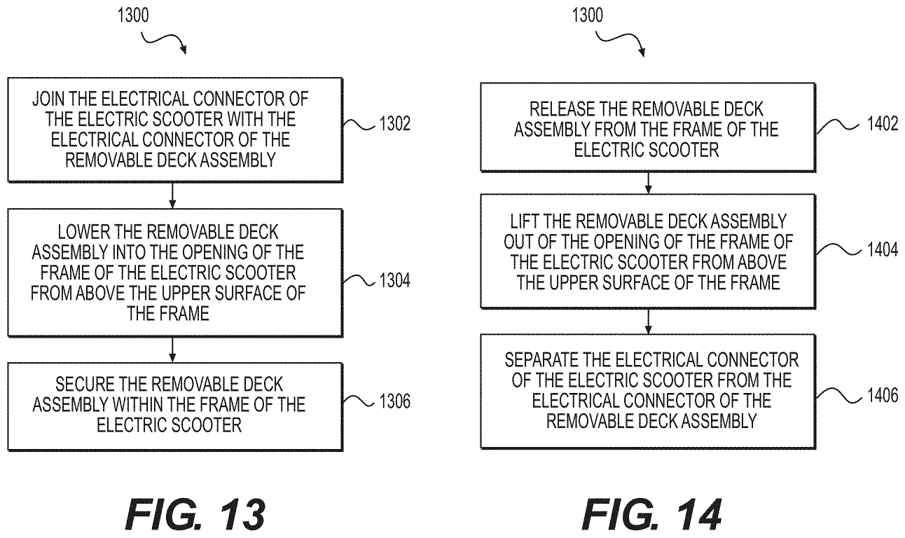

FIG. 13 illustrates a process 1300 for a user to install a removable deck assembly into an electric scooter according to embodiments of the disclosed technology. While elements of the process 1300 are described in a particular sequence. It should be understood that certain elements of the process 1300 may be performed in other sequences, may be performed concurrently, may be omitted, or any combination thereof.

Referring to FIG. 13, the user may join the electrical connector of the electric scooter with the electrical connector of the removable deck assembly, at 1302. The connectors may be joined as described above. The user may lower the removable deck assembly into the opening of the frame of the electric scooter from above the upper surface of the frame, at 1304, for example as described above. The user may secure the removable deck assembly within the frame of the electric scooter, at 1306, for example as described above.

FIG. 14 illustrates a process 1400 for a user to remove a removable deck assembly from an electric scooter according to embodiments of the disclosed technology. While elements of the process 1400 are described in a particular sequence, it should be understood that certain elements of the process 1400 may be performed in other sequences, may be performed concurrently, may be omitted, or any combination thereof.

Referring to FIG. 14, the user may release the removable deck assembly from the frame of the electric scooter, at 1402, for example as described above. The user may lift the removable deck assembly out of the opening of the frame of the electric scooter from above the upper surface of the frame, at 1404, for example as described above. The user may separate the electrical connector of the electric scooter from the electrical connector of the removable deck assembly, at 1406 for example as described above. Spatially relative terms such as “under,” “below,” “lower,” “over,” “upper,” and the like, are used for ease of description to explain the positioning of one element relative to a second element. These terms are intended to encompass different orientations of the device in addition to different orientations than those depicted in the Figures. Further, terms such as “first,” “second,” and the like, are also used to describe various elements, regions, sections, etc. and are also not intended to be limiting. Like terms refer to like elements throughout the description.

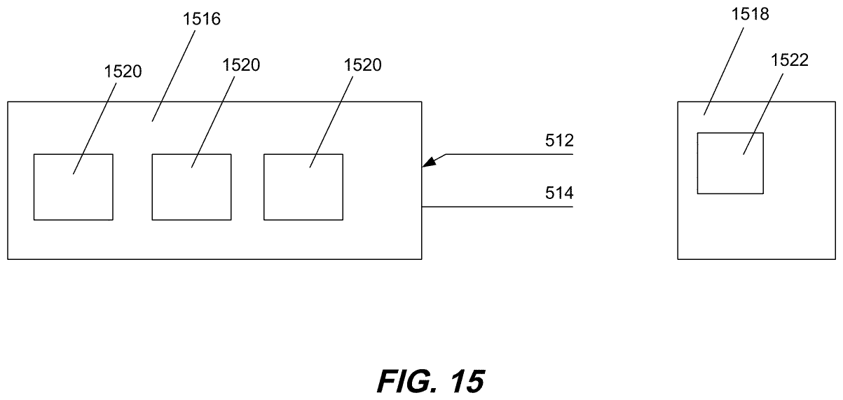

In one embodiment, illustrated in FIG. 15, electric vehicles 1516 are provided with systems and methods for vehicle security without a hardware secure element 1510. Hardware secure elements 1510 usually allow for the storage of private keys 1512, which are used to sign and encrypt data. In one embodiment the present invention removes the dependency on a hardware secure element 1510 as part of the whole security system.

Private keys and private key pairs (collectively 1512 and 1514) are used to cryptographically secure sensitive information. private keys 1512 can be used to decrypt, encrypt, or sign data. the corresponding public key 1514 can be used to decrypt or verify the signature of the data signed by its private key. public keys cannot be used to encrypt or sign data.

As a non-limited example, as used herein a vehicle 1516 is a means of carrying or transporting something including but not limited to an EV motor vehicle 1516, including but not limited to a scooter, skateboard, skates, and the like.

As used herein an encryption key is a piece of information that determines the functional output of a cryptographic algorithm. For encryption algorithms, a key specifies the transformation of plaintext into ciphertext, and vice versa for decryption algorithms. Keys also specify transformations in other cryptographic algorithms, such as digital signature schemes and message authentication codes.

As used herein, the cloud 1518 is a global network of servers, each with a unique function. The is not a physical entity, but instead is a vast network of remote servers around the globe which are hooked together and meant to operate as a single ecosystem. These servers are designed to either store and manage data, run applications, or deliver content or a service such as streaming videos, web mail, office productivity software, or social media. Instead of accessing files and data from a local or personal computer, you are accessing them online from any internet-capable device—the information will be available anywhere you go and anytime you need it. In the case of this embodiment the cloud 1518 is securely storing and generating public key and private key pairs for each component in the vehicle 1516.

As non-limiting examples, there are four different methods to deploy 8 resources.

These include: a public cloud 1518 that shares resources and offers services to the public over the Internet; a private cloud that isn't shared and offers services over a private internal network typically hosted on-premises; a hybrid cloud that shares services between public and private clouds depending on their purpose; and a community cloud 1518 that shares resources only between organizations, such as with government institutions.

In one embodiment, system 10 is coupled to the cloud 1518.

As used herein, a local area network (LAN) is a network that interconnects within a limited area such as a residence, school, laboratory, university campus or office building. By contrast, a wide area network (WAN) not only covers a larger geographic distance, but also generally involves leased telecommunication circuits. Ethernet and Wi-Fi are two common technologies in use for local area networks. Historical network technologies include ARCNET, Token ring, and AppleTalk.

As a non-limiting example, a wide area network (WAN) is a network that exists over a large-scale geographical area. A WAN connects different smaller networks, including local area networks (LANs) and metro area networks (MANs). This ensures that computers and users in one location can communicate with computers and users in other locations. WAN implementation can be done either with the help of the public transmission system or a private network.

As a non-limiting example, system 10 is coupled to the cloud. This can be achieved via GSM, WiFi, satellite, a mobile device and the like.

Other wireless standards that are specifically designed for IoT devices are becoming available such as Lora, NB-IOT and LTE-M, and the like.

As a non-limiting example, in one embodiment one or more hardware elements 1510 of the vehicle 1516 has public keys 1514 stored therein. Secure encryption is not put on the hardware elements 1510.

A vehicle 1516 consists of one or more in individual components 1520. Individual components 1520 of the vehicle 1516 are given an Acton Unique Identifier (AUIDs). When a vehicle 1516 is activated the first time, a unique public key 1514 and private key 1512 pair are generated by the cloud. AUIDs, public key and private keys 1514 and 1512 are then stored in the cloud. Each component stores its AUID and public key in persistent memory within the component thus eliminating theft of private keys 1512.

For selected components 1520 of the vehicle 1516, the cloud 1518 produces a unique private key 1512 and a public key 1514. As a non-limiting example, with the present invention, private keys 15112 are secure and in the cloud. They cannot be taken from the vehicle 1516. Non-limiting examples of vehicle 1516 components 1520 with public keys 1514 include but are not limited to: IOTA, the battery, motor controller, and the like.

As non-limiting examples, a simple electric vehicle 1516 can include a battery; vehicle control unit (motor controller), and IoT gateway. Each of these components 1520 is given an AUID. Additional components 1520 include but are not limited to vehicle locks; dashboards; helmets; docking stations; and the like.

As non-limiting examples, selected vehicle components 1520 have unique IDs with a unique identifier. These components 1520 are given a unique key pair. As a non-limiting example, the private key 1512 is securely stored in the cloud. An associated public key 1512 is stored in the vehicle components 1520. Communication in the cloud 1518 can be authenticated with the vehicle 1516 through the components 1520 that have public keys.

As a non-limiting example of authentication steps, public keys 1514 are passed to the vehicle 1516, e.g., vehicle components 1520. The private key 1512 is stored in the cloud, and the public key 1514 is transferred to a respective vehicle component.

As a non-limiting example, when the vehicle 1516 connects to the server 1522, it tells the server 1522 it has components 1520 A, B, and C. The System looks up in an associated database and generates an activation message composed of multiple parts, each part signed with the private key 1512 that corresponds to the AUID of the vehicle component A, B, or C 1510. When the activation message is received by the vehicle 1516, the individual components 1520 A, B, and C will decrypt and verify their parts of the message. If anyone component's message part fails verification, the vehicle 1516 will not activate.

As a non-limiting example, a secret key is not needed that unlocks the entire scoter. Instead, the system creates components 1520 are identified as being unique with associated keys.

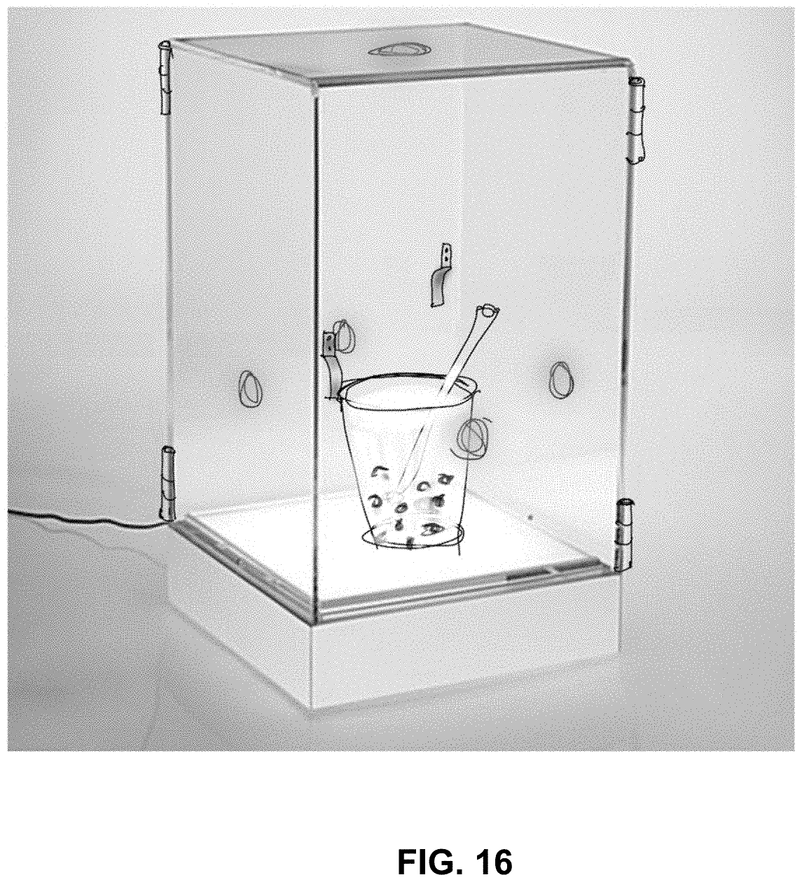

As illustrated in FIG. 16, in one embodiment fleets of vehicles are used to distribute information between vehicles in the fleet. As a non-limiting example, individual fleet vehicles have two wireless communication networks. The first is any kind of cloud 1518 connectively. The second one is any kind of local wireless communication.

When vehicles communicate with the cloud, they report their status occasionally. When they report status, they report the presence of other fleet-vehicles that they have detected on local wireless. As a non-limiting example, this status message can then be communicated with other fleet vehicles IDs that are within local communication. This provides information about the location of fleet vehicles, which can be used to reduce theft and increase fleet availability.

As a non-limiting example, data can be distributed to the fleet by seeding it to only certain vehicles, and these vehicles that receive the communications then communicate with other vehicles. Data that could be sent includes, but is not limited to updates, navigation information, vehicle configuration, secure one-time-keys. This mechanism decreases fleet-wide data-usage and improves fleet operation.

As a non-limiting example, a vehicle 1516 can detect, via local wireless communication, other vehicles, report their presence to the cloud, and the can then determine if another vehicle 1516 is located within a selected proximity. The cloud 1518 can then determine if the reporting vehicle 1516 can communicate data to the other vehicle. The cloud 1518 can then send a one-time use session key to the vehicles, allowing them to communicate securely.

When a vehicle 1516 communicates with the cloud 1518 that it sees another vehicle, it sends this message up to the cloud. The cloud 1518 can use this vehicle 1516 presence information to disable vehicles, track stolen vehicles, locate missing vehicles, and the like.

Fleet vehicles are vehicles operated by an entity that provides them for public or private use to individuals or employees. A fleet is a group of one or more Fleet Vehicles that an operator makes available for use. Private vehicles are vehicles operated by individuals for their own use.

In one embodiment, this invention can be used with both fleet and individual vehicles. If individual or fleet Operators of EV include their vehicle 1516 in this system, the benefits of lost vehicle 1516 discovery, reduced data usage, and the like can be extended across fleets and individuals. In this way, the fleet vehicles of Operator A can look for a stolen fleet vehicle 1516 of Operator B, while a private vehicle 1516 operated by individual C can receive software update data from Operator A's fleet.

When misplaced or stolen fleet or individual vehicles are located, the owner and/or authorities can be notified.

The coronavirus has been divided the virus into a plurality of sub-groupings, including but not limited to: 229E (alpha); NL63 (alpha); OC43 (beta); HKU1 (beta); MERS-CoV; SARS-CoV; SARS-CoV-2; and the like.

As non-limiting examples, UVC lights, 200-400 nm, can be provided, as well as any light that kills pathogens, including but not limited to light with intensity for a certain amount of time, lights that shine on the handlebar, or a plastic handle bar that is made with lights at interior.

In one embodiment, energy is supplied to the surface to equal to or exceed 60 degrees F.

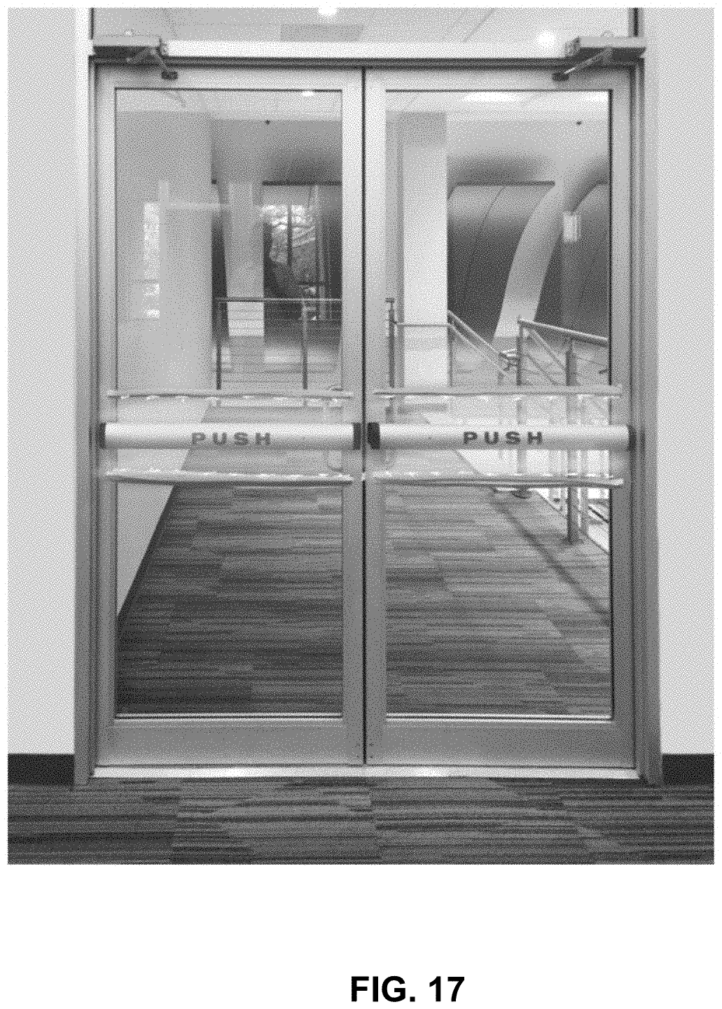

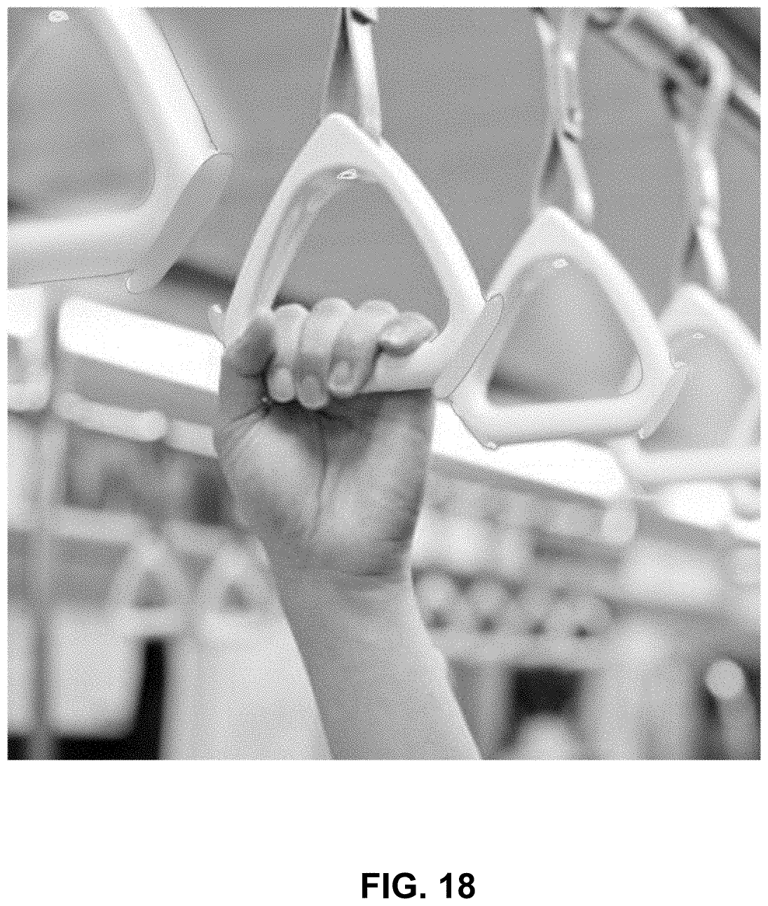

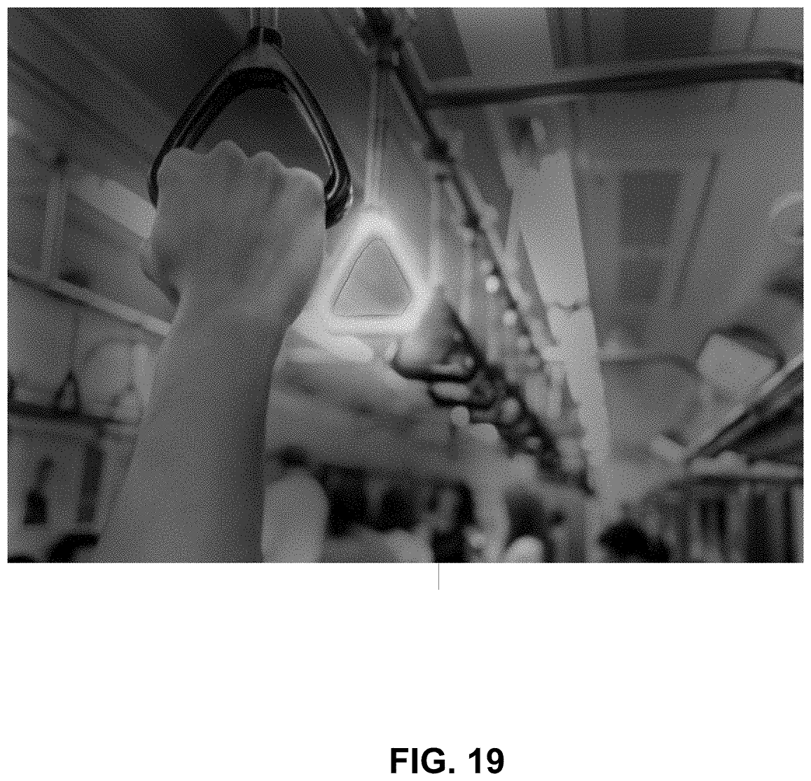

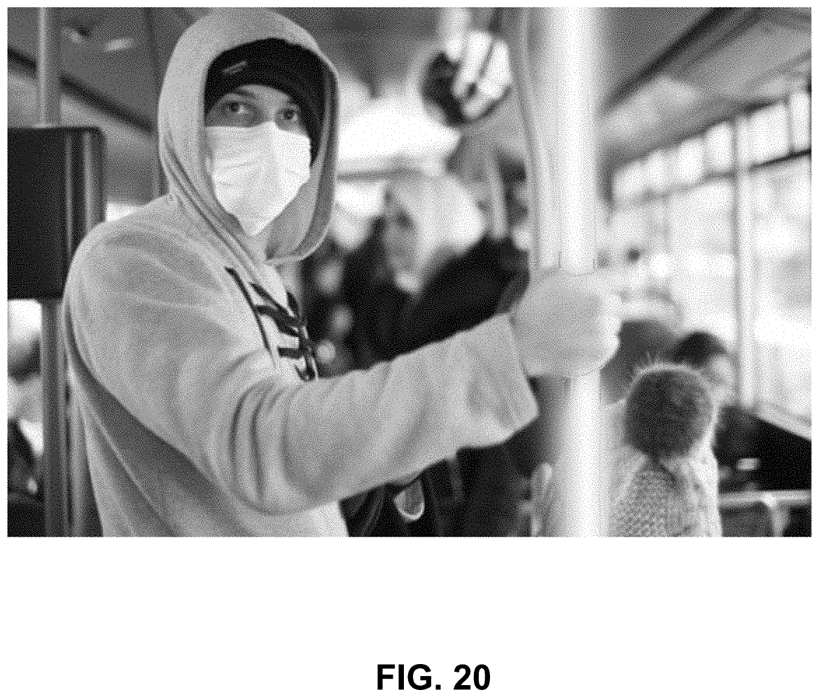

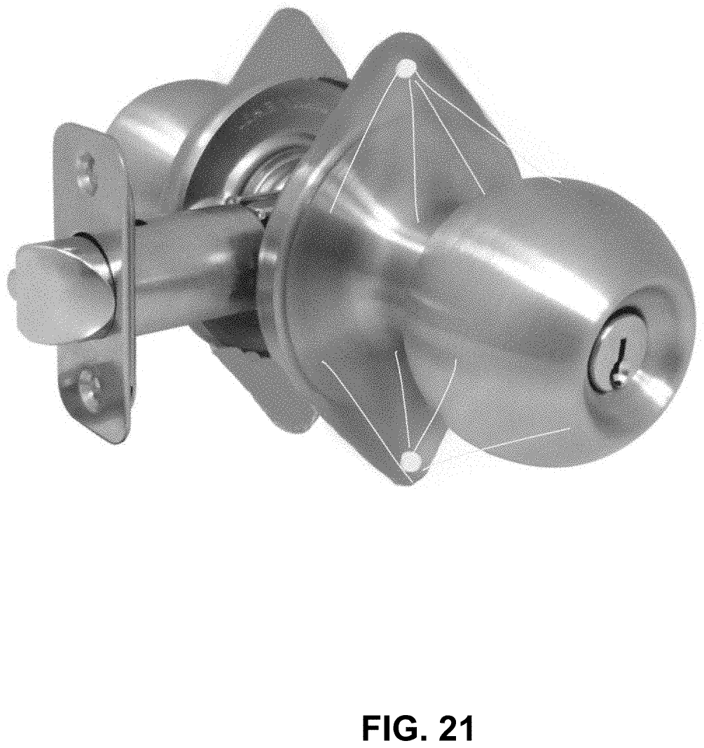

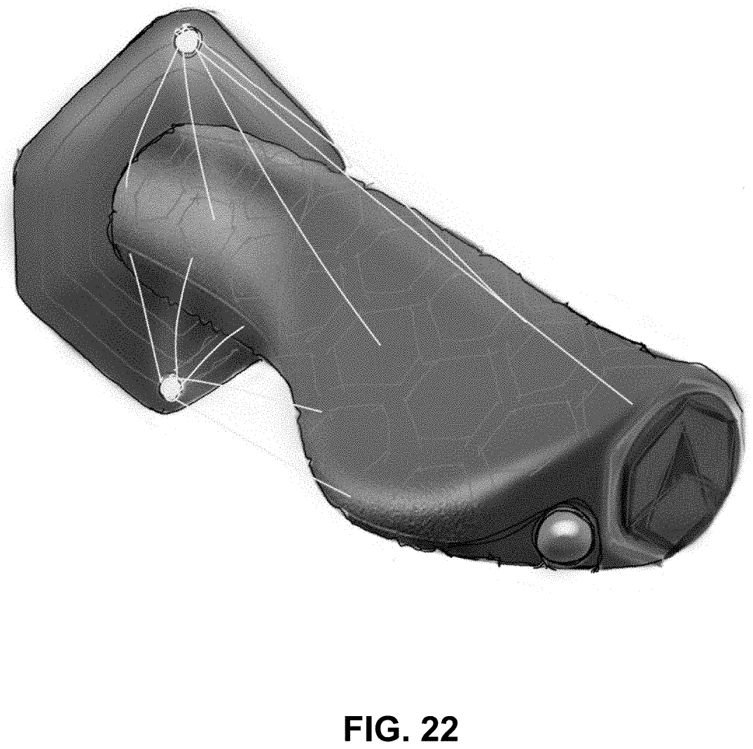

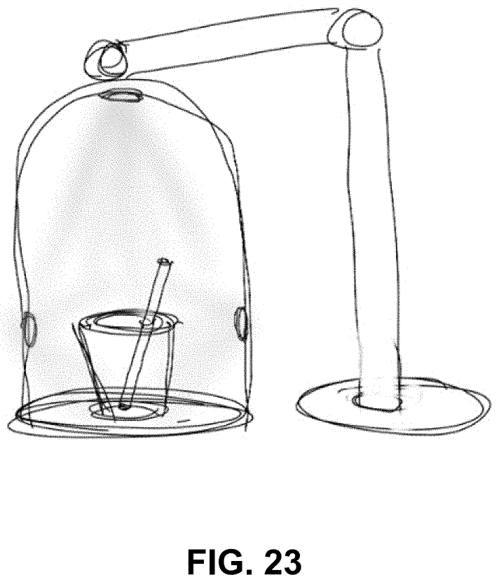

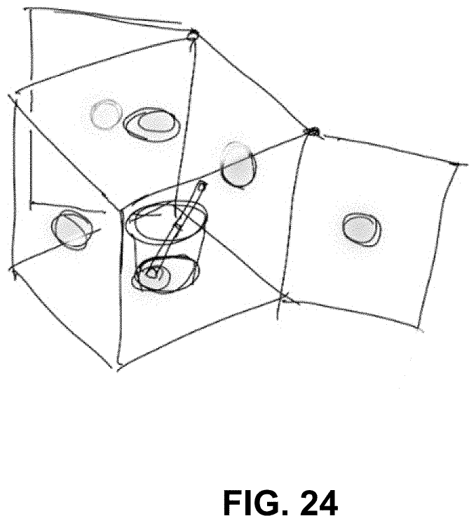

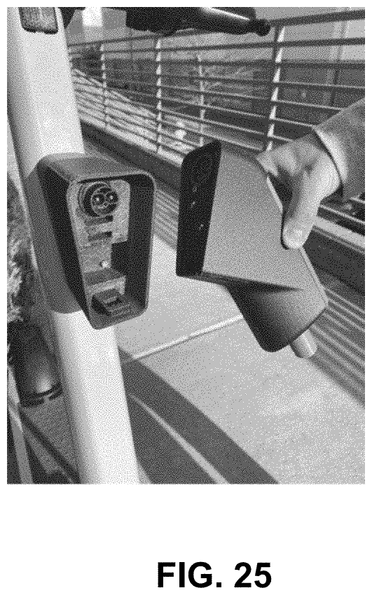

Referring to FIGS. 17-25 UVC can be used for different surface to kill the coronavirus, in one embodiment any surface of a vehicle, included but not limited to bicycles, electric vehicle, non-electric vehicle, and the like. that an operator or rider is in contact with, including but not limited to handlebars, as well as any surfaces that more than one-person use, including but not limited to: public transport surfaces, airline surfaces, bus handles, car handles, knobs, door knobs includes a light source 1610, disinefficient 1612 or the like, is provided that kills the coronavirus.

In one embodiment any type of handle device that people touch, externally with UV, or internally with the light shine inside.

As non-limiting examples, door knobs include but are not limited to: entrance door handles typically used on exterior doors, and include keyed cylinders; privacy door handles typically used on bedrooms and bathrooms; while they are lockable; passage knows such as hall or closet, these do not lock and are used in hall or closet doors.

As non-limiting examples, any type of handle device that people touch, externally with UVC, or internally with the light shine inside.

In one embodiment, UVC can be used with buttons touched by people. These buttons are

are difficult to avoid, which is part of the reason why push buttons can be crawling with germs.

Further, ubiquitous buttons, are found on ATMs, elevators, telephones and drink machines, among other things, are located in areas that are not often cleaned and disinfected to kill bacteria and viruses.

In another embodiment, any surface of a vehicle that an operator or rider is in contact with can be made from an antibacterial/antimicrobial plastic, or an associated exterior surface, where the operator or rider contacts, including but not limited to grips, brake levers, and the like, can be treated with an antibacterial/antimicrobial material. As a non-limiting example, an actual paint, applied at the factory, can include these elements. In one embodiment, the entire vehicle can be covered with the antibacterial/antimicrobial agent.

In one embodiment, ‘stickers’, which are essentially thin pieces of plastic with adhesive backing, can be attached to selected areas of the vehicle, including but not limited to brake levers, bells, throttles, other parts of high contact and the like.

As non-limiting examples, UVC lights, 200-400 nm, can be provided, as well as any light that kills pathogens, including but not limited to light with intensity for a certain amount of time, lights that shine on the handlebar, or a plastic handle bar that is made with lights at interior.

In one embodiment, energy is supplied to the surface to equal to or exceed 60 degrees F.

Referring to FIGS. 17-25 UVC can be used for different surface to kill the coronavirus, in one embodiment any surface of a vehicle, included but not limited to bicycles, electric vehicle, non-electric vehicle, and the like. that an operator or rider is in contact with, including but not limited to handlebars, as well as any surfaces that more than one-person use, including but not limited to: public transport surfaces, airline surfaces, bus handles, car handles, knobs, door knobs includes a light source 1610, disinefficient 1612 or the like, is provided that kills the coronavirus.

In one embodiment any type of handle device that people touch, externally with UV, or internally with the light shine inside.

As non-limiting examples, door knobs include but are not limited to: entrance door handles typically used on exterior doors, and include keyed cylinders; privacy door handles typically used on bedrooms and bathrooms; while they are lockable; passage knows such as hall or closet, these do not lock and are used in hall or closet doors.

As non-limiting examples, any type of handle device that people touch, externally with UVC, or internally with the light shine inside.

In one embodiment, UVC can be used with buttons touched by people. These buttons are

are difficult to avoid, which is part of the reason why push buttons can be crawling with germs.

Further, ubiquitous buttons, are found on ATMs, elevators, telephones and drink machines, among other things, are located in areas that are not often cleaned and disinfected to kill bacteria and viruses.

In another embodiment, any surface of a vehicle that an operator or rider is in contact with can be made from an antibacterial/antimicrobial plastic, or an associated exterior surface, where the operator or rider contacts, including but not limited to grips, brake levers, and the like, can be treated with an antibacterial/antimicrobial material. As a non-limiting example, an actual paint, applied at the factory, can include these elements. In one embodiment, the entire vehicle can be covered with the antibacterial/antimicrobial agent.

In one embodiment, ‘stickers’, which are essentially thin pieces of plastic with adhesive backing, can be attached to selected areas of the vehicle, including but not limited to brake levers, bells, throttles, other parts of high contact and the like.

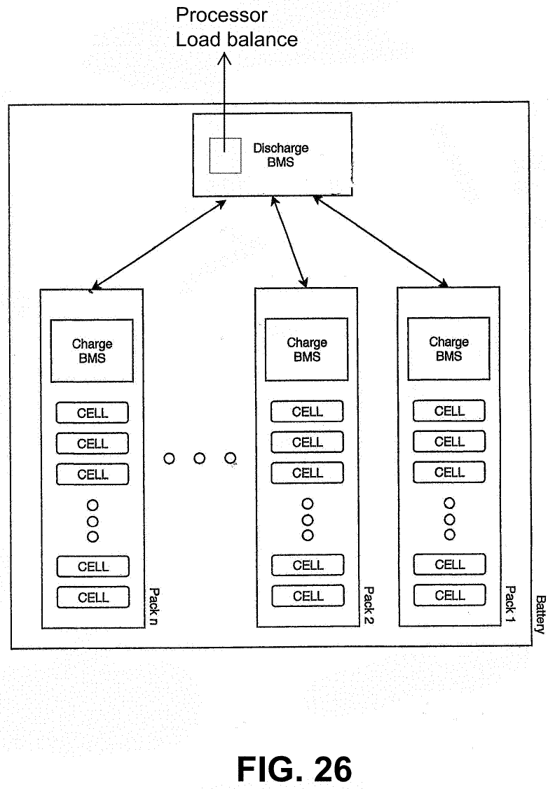

In one embodiment, illustrated in FIG. 26, a universal battery pack system includes a plurality of battery cell-packs. Battery management is separated into 2 layers, a charge layer and a second layer that is the discharge. This provides a separation of charge and discharge functionality. battery management. In one embodiment, a battery charger or station is used and a battery charge management system is provided that only functions as a charger and cell charger for the battery pack. The universal battery pack battery charge management system only monitors charging.

In one embodiment, separate charge and discharge systems are provided (charge BMS (BCMS) and discharge BMS (BDMS)). As a non-limiting example, the battery pack can be modular, with cell-packs 1 to cell-packs n, when charging, the system charges just the individual cell-pack.

In one embodiment, on discharge it may be necessary to know how many cell-packs are in a battery. This can be determined by the discharge BMS (battery discharge management system) (BDMS)

System provides for separate charge and discharge, battery management.

Each battery cell-pack has a charging management system that charges and manages the entire cell-pack. A discharge management system counts the number of cells. The Battery Discharge Management System (BDMS) counts the number of cell-packs and determines how much power and current is available depending on the number of cell-packs in the Battery Pack. This manages discharge, and allows for much more current available. In one embodiment, smart management of the packs is provided. In one embodiment, the system determines how depleted a battery pack is.

A state of charge is provided from each battery pack. The system determines and manages where to pull more power in order to load balance the cell-packs on its own. As a non-limiting example, multiple battery management systems are provided.

A plurality of sensors provides the Battery management system individual cell status, temperature, over and under voltage, over and under current, and other data to operate the Battery Pack safely

In one embodiment, a determination is made as to how many cell-packs are in the system with the battery discharge management system (BDMS). The BDMS can monitor each cell-pack and determine the optimal load management for the battery pack.

In one embodiment, the battery packs are monitored perpetually, and enables a determination as to how many times there is charge and discharge. In one embodiment, the discharge battery management system (BDMS) can differentiate between mismatched cell-packs and using load balancing algorithms to protect and extend the life of the cell-packs within the Battery Pack. As a non-limiting example, this can protect low charge battery packs from completely draining. In one embodiment, charge is taken from one battery pack to another battery pack.

In this manner, the system as a whole is protected, and allows the system from continuing to drawing power from a depleted cell-pack, reducing damage to battery cell-packs. A depleted battery can become too depleted, recovers less power over time. The system of the present invention uses the power of a battery pack up to a certain point and then it stops. This, with the discharge management system, selects the right battery pack to pull power from and then balances the battery pack so the batteries are depleted at about the same time. As a non-limiting example, this provides a system with active load management. In this manner, load balancing by the battery discharge management system prevents a battery cell-pack from getting close to depletion. As a non-limiting example, charge goes from one pack to another.

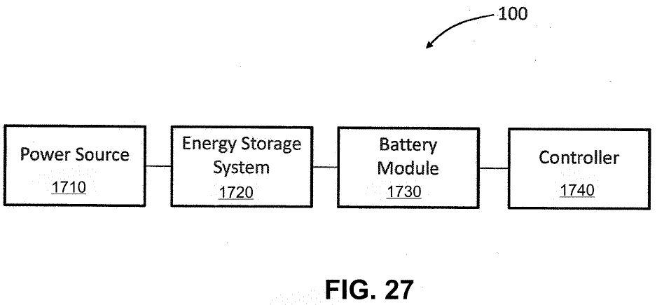

FIG. 27 illustrates one embodiment of a battery formation system 1700 with a power source 1710, an energy storage system 1720, one or more battery modules 1730, and a controller 1740. The battery modules 1730 can include individual cells, individual batteries, modules (e.g., a plurality of individual cells that are connected, for example, in series or parallel), or a battery pack (e.g., a plurality of modules that are connected, for example, in series or parallel) to form the module 1730. For example, the battery module 1730 can include 12 batteries connected in series, each of which has a specified voltage of 1.5 V, to form an 18-volt module. In another example, the battery module 1730 can include four 3.6 V Li-ion cells in series to achieve 14.4 V and two strings of these 4 cells in parallel to increase the capacity, for example, from 2400 mAh to 4800 mAh.

As non-limiting examples, the battery modules 1730 can be coupled to a plurality of cells, e.g., batteries, for charging and discharging in various configurations including but not limited in series, parallel and a combination of the two. In one embodiment, battery modules can be wirelessly charged at docking stations.

In one embodiment, energy storage system 1720 is coupled to the battery modules 1730. In one embodiment, energy is transferred bi-directional transferred between the energy storage system 1720 and the battery modules 1730. As a non-limiting example, energy storage system 1720 transfers energy from the energy storage system 1720 to the battery modules 1730 to charge the battery modules 1730. In a second operating state, the energy storage system 1720 is configured to transfer energy from the battery modules 1730 to the energy storage system 1720 to discharge the battery modules 1730. The energy transferred from the battery modules 1730 to the energy storage system 1720 can be stored for future use including, for example, recharging the battery modules 1730 for battery formation or testing. Through recycling the energy from battery discharging, energy consumption for the battery formation system 1700, and thus the overall battery manufacturing process, can be reduced.

As non-limiting examples, the energy storage system 1720 can be configured to charge a plurality of battery modules 1730 at substantially the same time, and then later discharge the same plurality of battery modules 1730. As non-limiting examples, the energy storage system can be configured to charge a first battery module 1730 (or a first set of battery modules 1730) and discharge a second battery module 1730 (or a second set of battery modules 1730) at substantially the same time. The energy storage system 1720 can be configured to charge and/or discharge any number of battery modules 1730 at substantially the same time. Said another way, the energy storage system 1720 can be electrically coupled to a plurality of individual battery modules 1730, or a plurality of sets of battery modules 1730, and each battery module 1730 or set of modules can be charged or discharged independent of the charging state of the rest of the plurality of modules 1730.

The energy storage system 1720 as used in the formation system 1700 can be selected from a variety of options. As non-limiting examples, the energy storage system 1720 can include one or more arrays of rechargeable batteries such as, for example, Lithium ion (Li-ion), Nickel cadmium (NiCd), Nickel Metal Hyride (NiMH), Sealed Lead Acid (SLA), Sodium Sulfide (NAS) or any other type of rechargeable batteries known in the art. As described herein, the array of rechargeable batteries can be configured deliver energy to the battery module 1730 for charging, and receive and store energy during discharge. Current technologies can produce energy storage systems 1720 with an output capacity of more than 1 MWh using lithium-ion cells.

As non-limiting examples, the energy storage system 1720 can include flow batteries. Flow batteries allow the batteries' power to be decoupled from the batteries' capacity, so users can tune the batteries' specification to specific applications and situations. Flow batteries used for constructing the energy storage system 1720 can be made from one or more of the following cells: Li-ion flow cells, redox cells in which electrochemical components are dissolved in the electrolyte, hybrid cells that have one or more electroactive components deposited as a solid layer, membrane less cells which employ laminar flow to undergo electrochemical reactions to store or release energy, organic cells that can use carbon-based molecules, for example, 9,10-anthraquinone-2,7-disulphonic acid (AQDS), as charge carriers, metal hydride cells which integrate a metal hydride storage electrode into a reversible proton exchange membrane fuel cell, and nano-network cells that uses lithium sulfur chemistry arranged in a network of nanoparticles. Energy storage medium in flow batteries can be, for example, Bromine-hydrogen, Iron-tin, Iron-titanium, Iron-chrome, Vanadium-vanadium (sulphate), Vanadium-vanadium (bromide), Sodium/bromine polysulfide, Zinc-bromine, Lead-acid, Zinc-cerium, or their combinations.

As non-limiting examples, the energy storage system 1720 can include superconducting magnetic energy storage (SMES) to store and deliver power. The energy system 1720, in this example, can comprise a superconducting coil to store the energy, a power conditioning system to coordinate the storage and release of powers, and a cooling system to cool the superconducting coil below its superconducting critical temperature. The electrical energy can be stored in a magnetic field created by the flow of direct current in the superconducting coil, which has nearly zero resistance and therefore will not decay the stored energy. Releasing the magnetic energy to either the utility grid or the battery charging module can be achieved by discharging the coil.

As non-limiting examples, the energy storage system 1720 can be a hybrid system with a battery system and fuel cells.

The power source 1710 is electrically coupled to the energy storage system 1720 and is configured to transfer energy from the power source to the energy storage system based on an amount of stored energy in the energy storage system. For example, the power source 1710 can provide start-up energy for the energy storage system 1720 to initiate the charging and discharging cycles in which this start-up energy is recycled. Moreover, when the amount of energy available in the energy storage system 1720 drops below a threshold level during charging and discharging cycles, the power source 1710 can be configured to transfer supplemental energy to the energy storage system 1720 to ensure proper operation of the formation system 1700. Said another way, the power source 1710 can compensate for energy losses in the energy storage system 1720. For example, an energy storage system 1720 comprising rechargeable battery arrays may lose part of the energy storage through heat generation and dissipation. In another example, an energy storage system 1720 including flywheel energy storage (FES) may need make-up power to compensate energy losses due to friction of the flywheels.

As non-limiting examples, energy transfer between the power source 1710 and the energy storage system 1720 can be configured to be bi-directional. For example, if the power source 1710 is a utility power grid, the energy storage system 1720 may use its stored energy to provide power to the grid during peak hours of energy use, and then receive “make-up” power during off-peak hours. Said another way, the energy storage system 1720 can be used for power grid load balancing. In another example, the energy storage system 1720 can function as a backup power supply by extracting energy from the batteries during unexpected power outage or during other emergencies.

As non-limiting examples, energy transfer between the power source 1710 and the energy storage system 1720 can be configured to be unidirectional. For example, if the power source 1710 is an intermittent power supply (e.g., renewable energy generation such as solar, wind, etc.), it may not be possible to employ bidirectional energy transfer. However, as non-limiting examples, the energy storage system 1720 can be electrically coupled to multiple power sources 1710 (e.g., solar, wind, and a utility grid) to utilize renewable power when available, utilize utility grid power when the renewable supply is not available, and even to store and transfer (e.g., balance) renewable energy when production is greater than demand (e.g., when the wind is blowing at night in the case of wind turbines).

The controller 1740 is operably coupled to the battery module 1730 and is configured to monitor and control a charging state of the battery module. Moreover, the controller 1740 can also be operably coupled to the energy storage system 1720 and configured to monitor and control a charging state of the energy storage system.

As non-limiting examples, the controller 1740 can be configured to monitor and control charging states at each level of the system 1700. Controller 1740 can determine when and where to send its stored energy. The controller 1740 can also adjust the timing of charging or discharging, which battery module to be charged or discharged, or how much energy to be stored or released, among others. Controller 1740 can regulate each battery to, for example, detect bad or outlier cells, balance cells, or connect/disconnect selected batteries, among others, therefore optimizing the battery formation process. As used herein, an outlier cell is a cell that acts differently from other cells during charge and/or discharge (for example, cannot be charged and/or discharged, or charges and/or discharges at a different rate than other cells).

As non-limiting examples, the controller 1740 can include two functional units: a diagnostic unit (not shown) and a control unit (not shown) to monitor and control the charging states, respectively. Charging states that can be monitored and/or controlled by the controller 1740 can include voltage, temperature, state of charge, state of health, coolant flow, and current, among others. The diagnostic unit can acquire charging states via several methods. For example, in a chemical method, charging states can be derived from the specific gravity or pH value of the electrolyte. In a voltage method, the voltage of the battery can be measured and converted to state of charge, using discharge curve of the battery. Similarly, measuring the battery current and integrating the measured current data in time can also provide information on the charging state, as in a current integration method, also known as a coulomb counting method. A Kalman filter can be used to enhance the accuracy of the voltage method and the current integration method by interpreting the raw data in a more accurate way. For some types of batteries, such as NiMH batteries, internal pressure increases as the batteries are charged, therefore allowing the derivation of charging states based on the internal pressure, as in a pressure method.

As non-limiting examples, the charging states acquired by the diagnostic unit of the controller 1740 can be used to generate control signals in order for the control unit of the controller 1740 to make corresponding adjustments. For example, a higher-than-average voltage on certain cells may indicate potential overcharging and can prompt the control unit to disconnect the cells for a while. In another example, a temperature out of a predetermined range may indicate low charging efficiency or potential hazard, in which case the control unit can act accordingly to bring the temperature back to the preset range.

As non-limiting examples, the control unit can also adjust charging states based on an external signal. For instance, when the energy storage system 1720 functions as a backup energy source, the controller 1740 can switch ongoing charging cycles to discharging cycles during unexpected power outages. In operation, the controller 1740 can be integrated with computer software to receive and analyze control signals from both inside and outside the system 1700 and achieve automated operation.

Controller 1740 can be coupled to (BMS) and monitor and control charging states of the batteries. The BMS, as used in the controller 1740, can include one or more of the following modules: cell protection, charge control, demand management, state of charge (SOC) determination, state of health (SOH) determination, cell balancing, history log, and communication, among others.

In the implementation illustrated in FIG. 7, energy storage system 1720 includes a load balancing module 1740. Load balancing module 1740 is configured to determine a load condition on one or more of the phases over which generator set(s) transmit power to drive load(s) 130. Load balancing module 1740 is configured to detect a load imbalance on one or more of the phases. In some embodiments, load balancing module 1740 may work alone or in conjunction with power monitoring module 1742 to monitor load conditions on the phases. In some embodiments, load balancing module 1740 may monitor a voltage of the phases and monitor load conditions and/or detect imbalances based on the voltage. In some embodiments, energy storage system 1720 may receive current signals from one or more current sensors (e.g., clamp-style sensors, in-line sensors, etc.) configured to monitor current flowing through one or more phases, and load balancing module 1740 may monitor load conditions and/or detect imbalances in load using the current signals.

Load balancing module 1740 is configured to control inverter 1744 to store power from generator set(s) 110 and/or transmit stored power to help drive load(s) 130 in response to the imbalance. In some embodiments, inverter 1744 may include separate single-phase inverters 705 for each of the phases. Each single-phase inverter 705 controls a flow of power into and out of energy storage system 1720 for a single phase. Load balancing module 1740 can independently control flow of power into and out of energy storage system 1720 by controlling single-phase inverters 1744 (e.g., via separate control signals transmitted to single-phase inverters 1744). In some embodiments, each single-phase inverter 1744 may be coupled to one or more secondary energy storage system 1720 (e.g., one or more batteries or one or more capacitors/supercapacitors) configured to temporarily store power transmitted from energy storage system 1720 before transmitting the power to help power a heavily loaded phase.

Load balancing module 1740 can be used to balance the load on the generator set/alternator phases and store the excess power of a previously unloaded phase in energy storage device 205. This stored power could then be used to provide spinning reserve, surge fill in, or allow generator set(s) 110 to turn off under light load or inefficient operating conditions, such that power for load(s) can be provided by energy storage system 1720. Under high, yet unbalanced load conditions, energy storage system 1720 could provide the extra power demanded to keep the heavily loaded phases from getting overheated or exceeding the alternator damage curve. This extra power could come from energy stored in energy storage device 205 and/or from pulling and transferring power from the more lightly loaded phases. For power transfer, power could be stored temporarily (e.g., by energy storage devices coupled to single-phase inverters 705) before being reconverted and pushed on to the heavy demand phases. In some embodiments, pure power electronics phase to phase direct conversion could be used.

Because the electricity flows in a fungible manner, energy storage system 1720 need not be an integral part of generator set(s) and can be a separate standalone unit. In some embodiments, energy storage system 1720 could be used as an add on to pre-existing generator sets or paralleled generator set farms of any origin, and they or their control systems would not necessarily need to know how energy storage system 1720 operates or even be able to communicate with energy storage system 1720 to still benefit. In some such situations, load balancing module 1740 could determine that the local power load is unbalanced and the correction needed (e.g., via current sensors and/or by monitoring the voltage differences in the phases. Other power factors could also be considered and incorporated, such as harmonics and power factor, etc. A correction could be applied to the grid using a feedback loop until the currents balance (e.g., within a threshold level of one another) or the voltage differences or other bad load characteristics are reduced or eliminated.

In some embodiments, load balancing module 1740 may determine and utilize one or more characteristics of generator set(s) in controlling operation of inverter 1744. If, for example, the alternator characteristics of generator set(s) were known, such as the generator damage curve, load balancing module 1740 can utilize this information in combination with the load condition information to control flow of power to and from energy storage device 205 to store excess power and/or help drive load(s) 130 on one or more phases. This may allow energy storage system 1720 to better manage generator set(s), such as by engage in phase peak shaving to prevent individual phases from becoming overloaded under high unbalanced load conditions. Further communications with the associated genset(s) (e.g., through a central controller or via a masterless load demand control (MLD) where energy storage system 1720 could appear as just another generator set) could allow for increased coordination and efficiencies (e.g., when dealing with a generator set farm with differing sized generator sets that can be switched on and off to meet load demand).

In some implementations, energy storage system 1720 can be used with small generator set installations, particularly multiple generator set sites such as with military applications. Energy storage system 1720 may provide automatic balancing of phases that generally will see varying and ad hoc load demands in such applications. Load balancing can provide an improved benefit for smaller alternators (e.g., due to magnitude of phase differences likely to be seen). In addition, power scavenged by phase balancing can be put to use in fuel savings with AC paralleling, as described above.

In some implementations, a utility grid connection feeding power onto a local power grid could have a weak phase or an unbalanced load demand upstream from the local power grid, leading to unstable power or local brown outs on select phases, yet may still be delivering the power being demanded. Some utilities charge power quality tariffs to users, in particular, industrial/commercial users, for exceptionally bad loads. Energy storage system 1720 could pull power from the good phases and push it onto the weak phase, as noted above for the heavily loaded genset (e.g., using direct phase to phase conversion or a local supercapacitor or other temporary storage). In these embodiments it is noted that the energy storage system 1720 and load balancing module 1740 can be paired with one or more generators, or installed as a standalone system to balance and correct the local grid supply or local loads.

It is to be understood that the present disclosure is not to be limited to the specific examples illustrated and that modifications and other examples are intended to be included within the scope of the appended claims. Moreover, although the foregoing description and the associated drawings describe examples of the present disclosure in the context of certain illustrative combinations of elements and/or functions, it should be appreciated that different combinations of elements and/or functions may be provided by alternative implementations without departing from the scope of the appended claims. Accordingly, parenthetical reference numerals in the appended claims are presented for illustrative purposes only and are not intended to limit the scope of the claimed subject matter to the specific examples provided in the present disclosure.

What is claimed is:

1. A universal battery with load balancing, comprising:
a battery module;
an energy storage system electrically coupled to the battery module and configured to bidirectionally transfer energy from and to the battery module, the energy storage system operable in a first operating state in which the energy is transferred from the energy storage system to the battery module to charge the battery module and a second operating state in which the energy is transferred from the battery module to the energy storage system to discharge the battery module;
an electrical connection electrically coupling the energy storage system to a power source; and
a controller operably coupled to the battery module and the energy storage system and configured to control a charging state of the battery module.

2. The universal battery of claim 1, wherein the battery modules include one or more of: individual cells; individual batteries; modules; and a battery pack.

3. The universal battery of claim 1, wherein the battery module includes a plurality of batteries connected in series.

4. The universal battery of claim 1, wherein the battery modules are coupled to a plurality of batteries for charging and discharging.

5. The universal battery of claim 1, wherein the battery modules are wirelessly charged at one or more docking stations.

6. The universal battery of claim 1, wherein energy is transferred bi-directional transferred between the energy storage system and the battery modules.

7. The universal battery of claim 1, wherein the energy storage system transfers energy from the energy storage system to the battery modules to charge the battery modules.

8. The universal battery of claim 1, wherein energy transferred from the battery modules 1 to the energy storage system is stored for future use including.

9. The universal battery of claim 1, wherein the energy storage system charges a plurality of battery modules.

10. The universal battery of claim 1, wherein the energy storage system charges the plurality of battery modules at substantially the same time.

11. The universal battery of claim 1, wherein each of a battery module is charged or discharged independent of a charging state of s rest of the plurality of modules.

12. The universal battery of claim 1, wherein the energy storage system provides an output capacity of more than 1 MWh.

13. The universal battery of claim 1, wherein the energy storage system includes flow batteries.

14. The universal battery of claim 1, wherein the flow batteries allow the batteries' power to be decoupled from the batteries' capacity.

15. The universal battery of claim 1, wherein, users can tune battery specification to specific applications and situations.

16. The universal battery of claim 1, wherein the energy storage system includes superconducting magnetic energy storage (SMES) to store and deliver power.

17. The universal battery of claim 1, wherein the energy storage system includes a superconducting coil to store energy.

18. The universal battery of claim 1, wherein the energy storage system includes a power conditioning system to coordinate the storage and release of power.

19. The universal battery of claim 1, wherein the energy storage system includes a cooling system.

20. The universal battery of claim 1, wherein energy from the energy storage system is released to a utility grid.
